(19) United States
(12) Patent Application Publication
(10) Pub. No.: US 2011/0093402 A1
(43) Pub. Date: Apr. 21, 2011

(54) ENSURING ACCEPTABILITY OF SOFTWARE LICENSE AGREEMENTS OR LEGAL AGREEMENTS

(75) Inventor: PRAMOD GUPTA, ONTARIO (CA)

(73) Assignee: INTERNATIONAL BUSINESS MACHINES CORPORATION, Armonk, NY (US)

(21) Appl. No.: 12/825,275

(22) Filed: Jun. 28, 2010

(30) Foreign Application Priority Data
Oct. 15, 2009 (CA) 2680594

(51) Int. Cl. G06Q 10/00; G06F 17/30

(52) U.S. Cl. 705/317; 707/780; 707/E17.058

(57) ABSTRACT

Techniques for ensuring acceptability of legal agreements entered into as part of a computer-facilitated workflow, e.g., for accepting a license agreement while installing software on a computer system owned by an organization. If the license has an approved status in an agreements database, the user can accept the license agreement during the software install process. If the license has a disapproved status in the agreements database, the user then rejects the license agreement during the software install process (or an install mechanism may simply aborts installation of the software). The process for other computer-facilitated workflows is similar.

### CROSS REFERENCE TO RELATED APPLICATIONS

This application claims priority to Canadian patent application, Serial Number 2680594, filed on Oct. 15, 2009, which is hereby incorporated by reference in its entirety.

### BACKGROUND OF THE INVENTION

1. Field of the Invention

Embodiments of the invention generally relate to techniques for managing legal obligations. More specifically, embodiments of the invention relate to ensuring acceptability of software license agreements or legal agreements.

2. Description of the Related Art

For large organizations, it is difficult to monitor all the software being used by employees or other agents. In particular, large organizations may be unable to successfully monitor whether each and every software license under which software is installed on computer systems owned by an organizations are (or at least deemed to be) acceptable for use by the organization. Further, such licenses are often complex documents, making them difficult to understand. As a result, many people simply click “OK” and accept the various licenses without fully understanding the implications when installing software applications on an organization's computer system. In some cases, this may bind the organization to terms that organization finds unacceptable.

The same result happens in other computer-facilitated workflows where an agent of an organization enters a legal agreement which binds the organization, e.g., when opening an on-line bank (or other financial) account or engaging in other forms of electronic contracting, such as accepting the terms of an electronic purchase order. In these examples, a non-lawyer may have to accept terms of an agreement, ultimately, on behalf of the organization. And as noted, such agreements are frequently large and complex, resulting in employees or agents agreeing to the terms—typically by clicking on an “OK” or “I Accept” button in an electronic workflow—without fully understanding certain aspects of a given agreement.

At the same time, such agreements may have a serious impact on an organization. Hence, it is important to ensure that each software license agreed to during software installation, or agreement accepted during other computer-facilitated workflows accepted by an employee, is acceptable to the organization.

### SUMMARY OF THE INVENTION

One embodiment of the present invention includes a computer-implemented method for ensuring acceptability of an agreement entered into as part of a computer-facilitated workflow. The method may generally include receiving, from a user engaging in the computer-facilitated workflow, a text representation of a first agreement presented to the user as a step of the computer-facilitated workflow; and comparing, by operation of a processor, the text representation of the first agreement to a text representation of a plurality of agreements stored in an agreements database. The method may also include determining, in response to the comparison, whether a first agreement matches a second agreement, the second agreement having an assigned status in the agreements database; and transmitting, over a data communications network, an indication to the user of the assigned status of the second agreement.

Sill another embodiment of the invention includes a computer-readable storage medium containing a program which, when executed by a processor, performs an operation for ensuring acceptability of an agreement entered into as part of a computer-facilitated workflow. The operation itself may generally include receiving, from a user engaging in the computer-facilitated workflow, a text representation of a first agreement presented to the user as a step of the computer-facilitated workflow; and comparing, by operation of a processor, the text representation of the first agreement to a text representation of a plurality of agreements stored in an agreements database. The operation may also include determining, in response to the comparison, whether a first agreement matches a second agreement, the second agreement having an assigned status in the agreements database; and transmitting, over a data communications network, an indication to the user of the assigned status of the second agreement.

Still another embodiment of the invention includes a system having one or more computer processors and a memory containing a program, which when executed by the one or more computer processors is configured to perform an operation for ensuring acceptability of an agreement entered into as part of a computer-facilitated workflow. The operation itself may generally include receiving, from a user engaging in the computer-facilitated workflow, a text representation of a first agreement presented to the user as a step of the computer-facilitated workflow; and comparing, by operation of a processor, the text representation of the first agreement to a text representation of a plurality of agreements stored in an agreements database. The operation may also include determining, in response to the comparison, whether a first agreement matches a second agreement, the second agreement having an assigned status in the agreements database; and transmitting, over a data communications network, an indication to the user of the assigned status of the second agreement.

Yet another embodiment of the invention includes a computer-implemented method for ensuring acceptability of a software license entered into as part of a software installation workflow. This method may generally include receiving, from a user engaging in the software installation process, a text representation of the software license presented to the user as a step of the software installation process and comparing, by operation of a processor, the text representation of the software license to a text representation of a plurality of software licenses stored in a database. This method may also include determining, in response to the comparison, whether the software license matches at least a second software license in the database, the second software license having an assigned status in the agreements database and transmitting, over a data communications network, an indication to the user of the assigned status of the second software license agreement.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a computing infrastructure configured for ensuring compliance of software license agreements or legal agreements, according to one embodiment of the invention.

FIG. 2 is a more detailed view of the server computing system of FIG. 1, according to one embodiment of the invention.

FIG. 3 is an example database schema for an agreements database, according to one embodiment of the invention.

FIG. 4 is a more detailed view of the client system of FIG. 1, according to one embodiment of the invention.

FIG. 5 illustrates a method for ensuring acceptability of software license agreements or other legal agreements entered into as part of a computer-facilitated workflow, according to one embodiment of the invention.

FIG. 6 illustrates a method of an exception process used to approve (or disapprove) legal agreements encountered during a computer-facilitated workflow, according to one embodiment of the invention.

### DETAILED DESCRIPTION

Embodiments of the invention are generally directed to techniques for ensuring acceptability of legal agreements entered into as part of a computer-facilitated workflow. For example, a license agreement presented to a user installing software on a computer system owned by an organization may be evaluated for acceptability during the installation process. In one embodiment, an organization may maintain an agreements database of approved (and disapproved) software licenses and legal agreements. Each software license having an approved (or disapproved) status may be stored in a record of the agreements database. Such a record may include, e.g., an identifier such as a license name, a license version, license text, an indication of whether the license has been approved or disapproved, and any other relevant information. When a new software license is submitted to a license authorization application, it may be forwarded to an appropriate party within the organization for evaluation. Once the license is analyzed and approved (or disapproved), a new record in the license agreement database may be created.

When a user installs software (or engages in some other computer facilitated workflow), the user may be presented with a screen asking the user to either (i) accept the license agreement and continue installing or (ii) reject the agreement and exit from the install workflow. In one embodiment, the user opens a browser window and logs on to a web site providing an interface to the license agreement database of approved and disapproved licenses. The user may cut and paste the license text into the web-interface and request license authorization application identify whether the particular agreement is an approved or disapproved license. In an alternative embodiment, the computer system on which the software is being installed may have an install mechanism configured to submit the license to the agreements database and allow the installation to proceed (or not) as appropriate.

Once the text of the license is received, the license authorization application may then search the agreements database for a match and present the user with the response of whether the license is approved, disapproved, or unknown. If the license has an approved status in the agreements database, the user can accept the license agreement during the software install process (or the install mechanism may simply proceed to install the software). If the license has a disapproved status in the agreements database, the user then rejects the license agreement during the software install process (or the install mechanism may simply aborts installation of the software). The process for other computer-facilitated workflows is similar. For example, a user may be presented with an agreement as part of an on-line purchase order. In such a case, the user may cut and paste the text of the purchase order terms into the web-interface and request license authorization application identify whether the particular agreement is an approved or disapproved license. If such an agreement has not been evaluated, the user can open a request to have it evaluated and added to the agreements database.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Further, a particular embodiment of the invention are described using a software installation and licensing application as particular example of a method for ensuring compliance of software license agreements or legal agreements. However, it should be understood that the invention may be adapted to for a broad variety of electronic workflows which require a user to accept to terms legally binding to the individual user and/or an organization, e.g., any process of procurement, banking and/or credit account applications, or more generally any process that includes electronic contracting. Accordingly, references to software installation and licensing are merely illustrative and not limiting.

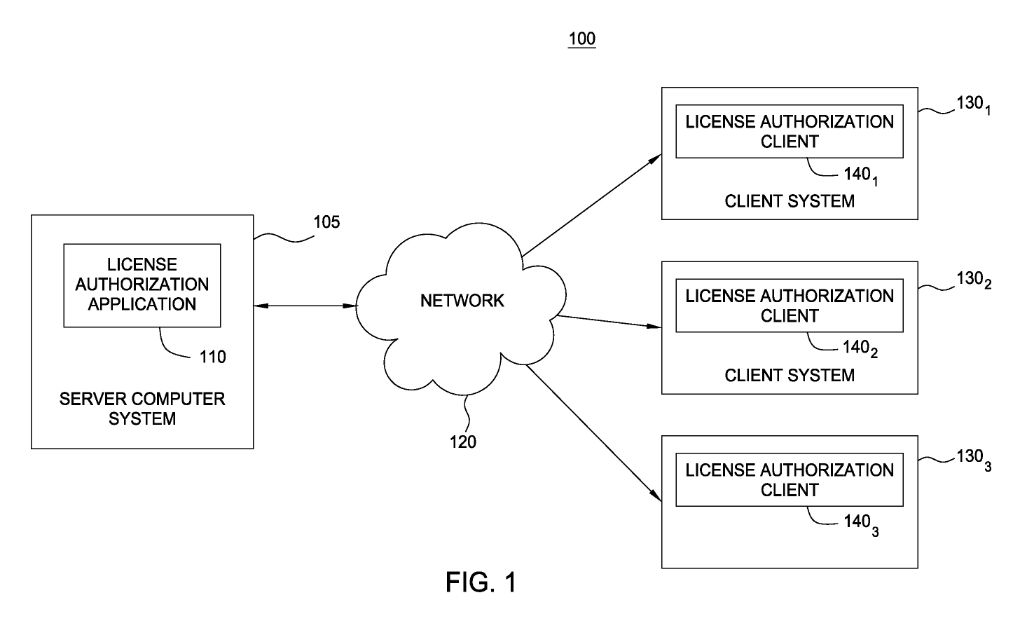

FIG. 1 illustrates a computing infrastructure 100 configured for ensuring compliance of software license agreements or legal agreements, according to one embodiment of the invention. As shown, the computing infrastructure includes a server computer system 105 and a plurality of client systems 130₁₋₃, each connected to a communications network 120.

Illustratively, each of the client systems 130₁₋₃ communicates with the server system 105 over the network 120 to determine the status of an agreement (e.g., a software licensing agreement) encountered as part of a computer-facilitated workflow (e.g., a workflow to install the software on the client system 130). In one embodiment, the client systems 130₁₋₃ may include a license authorization client 140 configured to provide the text of an agreement to a license authorization application 110 running on the server system 105. For example, the authorization client 140 may be a user interface downloaded from the server computer system 105 and rendered by a web browser on the client system 130. In such a case, the user may cut and paste (or otherwise provide) the text of a license to the license authorization application 110. Of course, other approaches may be used.

The server computer system 105 includes the license authorization application 110. As described in greater detail below, the authorization application 110 may be configured to identify whether the text of a given agreement has an approved (or disapproved) status within an organization, as well as receive requests to add additional agreements to an agreements database.

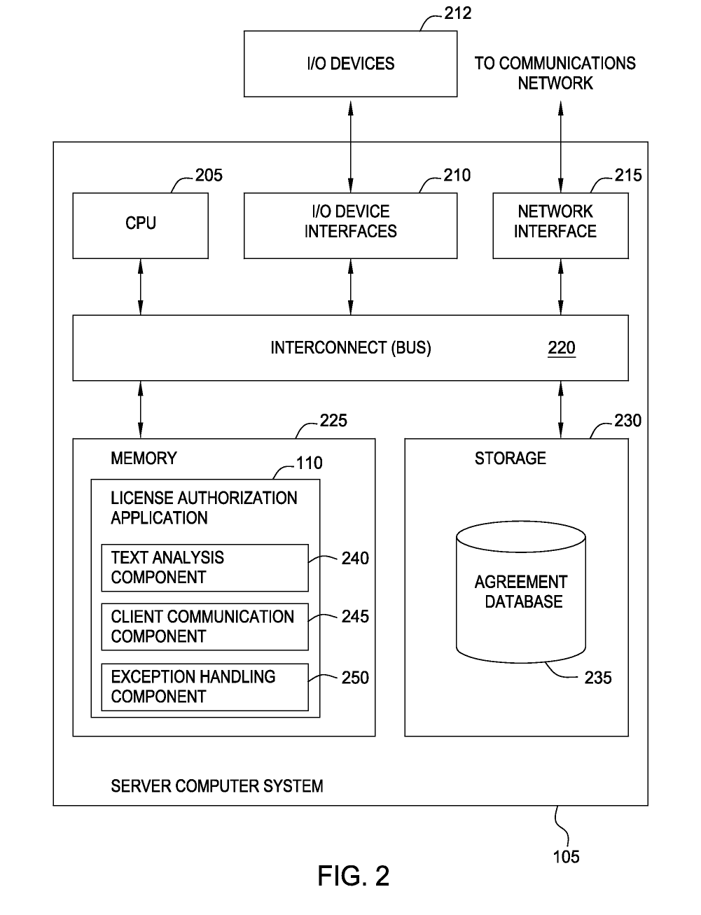

FIG. 2 is a more detailed view of the computing system 105 of FIG. 1, according to one embodiment of the invention. As shown, the server computing system 105 includes, without limitation, a central processing unit (CPU) 205, a network interface 215, an interconnect 220, a memory 225, and storage 230. The computing system 105 may also include an I/O devices interface 210 connecting I/O devices 212 (e.g., keyboard, display and mouse devices) to the computing system 105.

The CPU 205 retrieves and executes programming instructions stored in the memory 225. Similarly, the CPU 205 stores and retrieves application data residing in the memory 225. The interconnect 220 facilitates transmission of programming instructions and application data between the CPU 205, I/O devices interface 210, storage 230, network interface 215, and memory 225. CPU 205 is included to be representative of a single CPU, multiple CPUs, a single CPU having multiple processing cores, and the like. And the memory 225 is generally included to be representative of a random access memory. The storage 230 may be a disk drive storage device. Although shown as a single unit, the storage 230 may be a combination of fixed and/or removable storage devices, such as fixed disc drives, floppy disc drives, tape drives, removable memory cards, optical storage, network attached storage (NAS), or a storage area-network (SAN).

Illustratively, the memory 225 includes the license authorization application 110 of FIG. 1. As shown, the authorization application 110 includes a text-analysis component 240, a client communication component 245 and an exception handling component 250. And storage 230 includes an agreement database 235. In one embodiment, the text-analysis component 240 may be configured to receive the text of a license agreement from a client and determine whether the agreement has an approved or disapproved status within an organization. For example, the text-analysis component 240 may compare the text of an agreement with the text of a collection of agreements stored in the agreement database 235. If a match is found then the status of the agreement is supplied to a requesting user.

If a match is not found, the text-analysis component 240 may identify whether any similar agreements are in the agreements database 235. In such a case, the text-analysis component 240 may present a user with the differences between received text and an approved or disapproved agreement in the agreements database 235. For example, an open-source license may include a copyright legend or other information that changes from use-to-use of the license. In such a case, when presented with a text-based comparison, a user may elect to apply the status of an agreement form the agreements database 235 to a license presented during a software install workflow. Further, the agreements database 235 may be updated with the similar variant—allowing an exact match to be presented to subsequent users of the license authorization application 110 for a particular software application. If the user decides that the changes are more substantial, then the user may invoke an exception process allowing a particular agreement to be reviewed and added to the agreements database 235 along with an approved or disapproved status assigned as part of the review.

Similarly, if the text-analysis component 240 does not identify a matching agreement (or a similar agreement), the text of such an agreement may be passed to the exception handling component 250. In response, the exception handling component 250 may be configured to forward the text to an appropriate party within an organization for evaluation. Once a response is received indicating the new agreement should have an approved (or disapproved) status, the exception handling component 240 may create a record in the license agreement database 235 reflecting the status of the new agreement. Further, the user that submitted the new agreement for evaluation may also be provided with an update indicating whether the agreement was given an approved (or disapproved) status.

The client communication component 245 may be configured to facilitate communications between the license authorization application 110 and a client system. For example, the client communication component 245 may include (or interact with) a web-server configured to provide an interface to a client system and to supply the text of given agreement to the text-analysis component 240. Of course, one of ordinary skill in the art will recognize that a variety of application servers, web servers, etc., may be adapted for use with an embodiment of the invention.

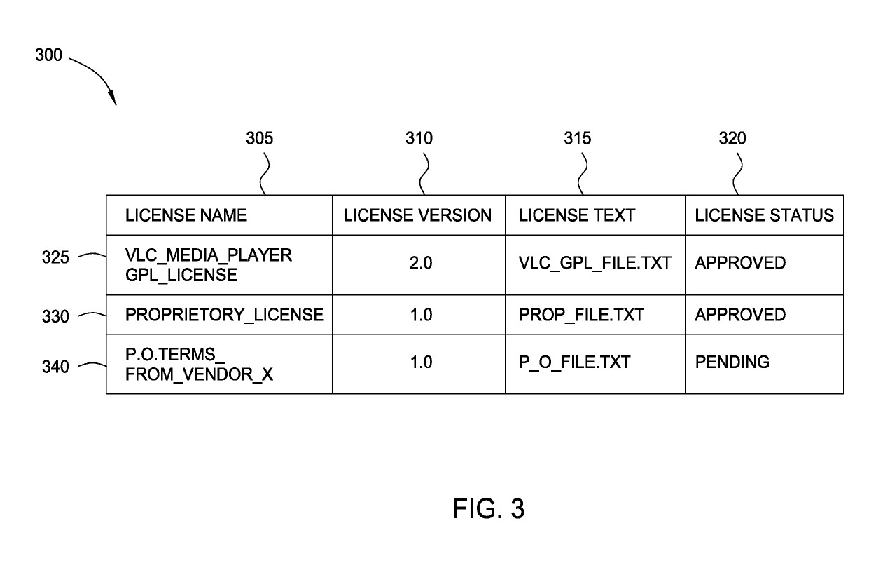

FIG. 3 is an example database schema for an agreements database, according to one embodiment of the invention. In this example, the database schema is presented as a relational table 300, where each row of the table includes data for a different agreement approved or disapproved within a given organization. As shown, the table 300 includes a “license name” column 305, a “license version” column 310, a “license text” column 315 and a “license status” column 320.

Illustratively, the table 300 includes data for three records 325, 330, and 335. Each record represents an agreement (e.g., as software license or other agreement) that has been reviewed and assigned an approved (or disapproved) status within an organization. For example, record 325 references a licensee name of “VLC_Media_Player_GPL_License.” This particular license has a version of “2.0,” the text of this license is stored in a file named “VLC_GPL_file.txt,” and has an “approved” status. Similarly, record 330 includes information for a “proprietary_license” and record 340 includes information for a purchase order agreement. In this example, the status for records 235 and 330 are shown as “approved” and the status for record 340 is shown as “pending,” meaning that the text of this agreement has been submitted for review, but not yet assigned an approved or disapproved status.

In one embodiment, the status of an agreement may be a straightforward approved, disapproved, or pending. Alternatively, however, the use of a given software license (or other agreement) may depend on the user making a request, a user's role within an organization, or any other factors as appropriate in particular case. In such cases, the schema for the agreements database 235 may include additional columns or tables in order for the license authorization application 110 to determine a response to a request to approve (or disapprove) the use of a particular agreement encountered during a computer-facilitated workflow.

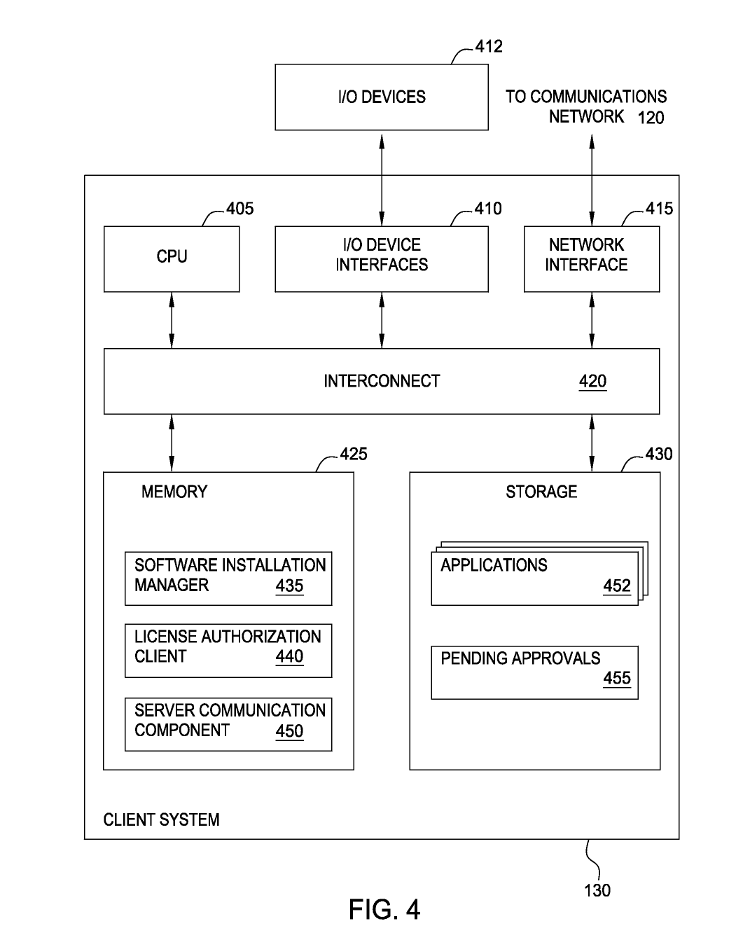

FIG. 4 is a more detailed view of the client system 130 of FIG. 1, according to one embodiment of the invention. As shown, client system 130 includes, without limitation, a central processing unit (CPU) 405, a network interface 415, an interconnect 420, and a memory 425. The client system 130 may also include an I/O devices interface 410 connecting I/O derives 412 (e.g., keyboard, display and mouse devices) to the client system 130.

The CPU 405 is configured to retrieve and execute programming instructions stored in the memory 425 and storage 430. Similarly, the CPU 405 is configured to store and retrieve application data residing in the memory 425 and storage 430. The interconnect 420 is configured to facilitate data transmission, such as programming instructions and application data, between the CPU 405, I/O devices interface 410, storage unit 430, network interface 405, and memory 425. Like CPU 205, CPU 405 is included to be representative of a single CPU, multiple CPUs, a single CPU having multiple processing cores, and the like. Memory 425 is generally included to be representative of a random access memory. Storage 430, such as a hard disk drive or flash memory storage drive, may store non-volatile data. The network interface 415 is configured to transmit data via the communications network 120.

As shown, the memory 425 stores programming instructions and data, including a software installation manager 435, a license authorization client 440, and a server communication component 445. In one embodiment, the license authorization client 440 provides an interface for a user to transmit the text of a given agreement (e.g., a software license agreement), encountered during a computer-facilitated workflow to the license authorization application 110. For example, the license authorization client 440 may be implemented as an interface rendered on a web-browser. Such an interface may allow the user to cut and paste the text of a software license agreement into a form submitted to the license authorization application 110. Similarly, computer-facilitated workflows such as an enrollment agreement presented during a process for subscribing to an on-line service, or an application process for establishing a bank or credit account, or an on-line purchase order process may at some point present a set of terms and conditions which need to be accepted by the user before the computer-facilitated workflow can proceed. In such cases, the user may cut and paste the text of an agreement presented during the workflow into a form presented by the license authorization client 440. Once a response is received indicating that the particular license (or other agreement) is approved (or disapproved), the user may then proceed with the computer-facilitated workflow.

Alternatively, however, the client system 130 may provide a standard workflow for installing new software applications. For example, some operating systems provide a standard install process for installing and removing software, and the install process may require a user accept a license agreement during the installation of a new software application. In such a case, the software installation manager 435 may be configured to retrieve the text of a license presented to a user during the installation process and transmit it to the license authorization application 110. Further, the software installation manager 435 may block the installation process for agreements being installed under a license having a disapproved status in the agreements database 235.

As shown, storage 430 includes a set of installed applications 452 and pending approvals 455. The installed applications represent a collection of software installed on the client system 450. Pending approvals represent computer-facilitated workflows that have been initiated, but not completed, while the text of a given agreement is submitted for evaluation.

The sever communication component 445 may be configured to facilitate communications between the client system 130 and the server computing system 105. For example, the client communication component 245 may include a web-browser configured to request and render an interface retrieved from the license authorization application 110 and to present an interface indication of the approval (or disapproval) of a given agreement.

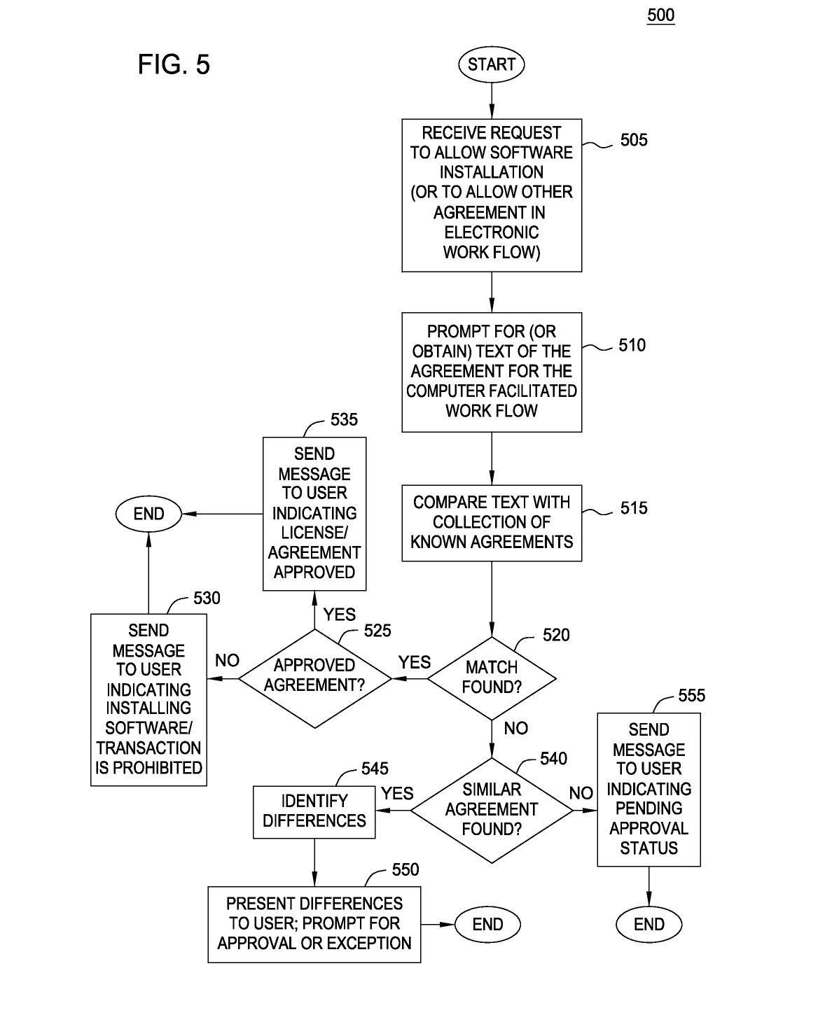

FIG. 5 illustrates a method 500 for ensuring acceptability of software license agreements or other legal agreements entered into as part of a computer-facilitated workflow, according to one embodiment of the invention. As shown, the method 500 begins at step 505, where the license authorization application 110 receives a request to allow a software application to be installed under the terms of a given software license—or to allow a user to accept the terms of an agreement as a part of another computer-facilitated workflow. At step 510, the license authorization client 440 may prompt the user to supply the text of the relevant agreement. For example, as noted above, a user may cut and paste the text of the relevant agreement into from provided on a web-based interface rendered in a browser window. Alternatively, the software installation manager 435 on the client system 130 may recognize when the user initiates a software installation workflow which requires the user to accept the terms of a given license. In such a case, the software installation manager 435 may transmit the text of a given agreement to the license authorization application 110.

At step 515, the text-analysis component 240 may compare the text of a given agreement with a collection of known licensing agreements stored in an agreements database 235. At step 520, if a match is found (i.e., the text of an agreement encountered during a computer-facilitated workflow matches the text of an agreement in the agreements database 235), then the license authorization application 110 may determine an approval status assigned to the agreement (step 525). If the agreement has an approved status, then the license authorization application 110 may send a message to the user indicating the licensing agreement is approved (step 535). That is, a message indicating that the user may accept the terms of the agreement. Otherwise, if the agreement has a disapproved status, then the license authorization application 110 may send a message to the user indicating the licensing agreement is not approved (step 530). That is, a message indicating that the user should not continue with the particular computer-facilitated workflow (e.g., should not install the software application).

Returning again to step 520, if a match is not found between a given agreement and the collection of agreements in the agreements database 235, then at step 540, the text-analysis component 240 may determine whether a similar agreement is found. A variety of techniques may be used to measure similarity between the submitted agreement and agreements in the agreements database 235. For example, text-analysis component may determine a statistical measure of a number of matching words, phrases, clauses, or paragraphs, between the submitted agreement and a given agreements from the agreements database 235. In one embodiment, if the measure of similarity for a given agreement from the database 235 exceeds a user-specified threshold, then that agreement is considered “similar” by the license authorization application 110.

At step 540, if such a “similar” agreement is found, the text-analysis component 240 may identify the differences between the text of the submitted agreement and the one deemed to be similar. And at step 550, such differences may be presented to the user. For example, the differences may be presented as a side-by-side comparison to highlight the differences between the text of the submitted agreement and the similar one or the differences may be presented using text strike through (for deleted text) and underline (for added text) to show editing changes between one agreement and another.

In response, the user may specify whether the submitted agreement should be assigned the same status as the similar one or should be handled via an exception process. In one embodiment, if the user selects to assign the same status to the submitted agreement, then the text of that agreement may be added to the agreements database, allowing an exact match to occur should the agreement subsequently be presented to the license authorization application 110. Otherwise, the agreement may be assigned a “pending” status until an appropriate party within an organization for reviews the agreement and assigns an approved or disapproved status. In such a case, the user may discontinue a given particular computer-facilitated workflow until the status of the agreement is updated.

Returning again to step 540, if a similar licensee cannot be identified, then at step 555, the license authorization application 110 may send a message to a user indicating that the agreement has been assigned a “pending” status and that the user should discontinue a given particular computer-facilitated workflow until the status of the agreement is updated.

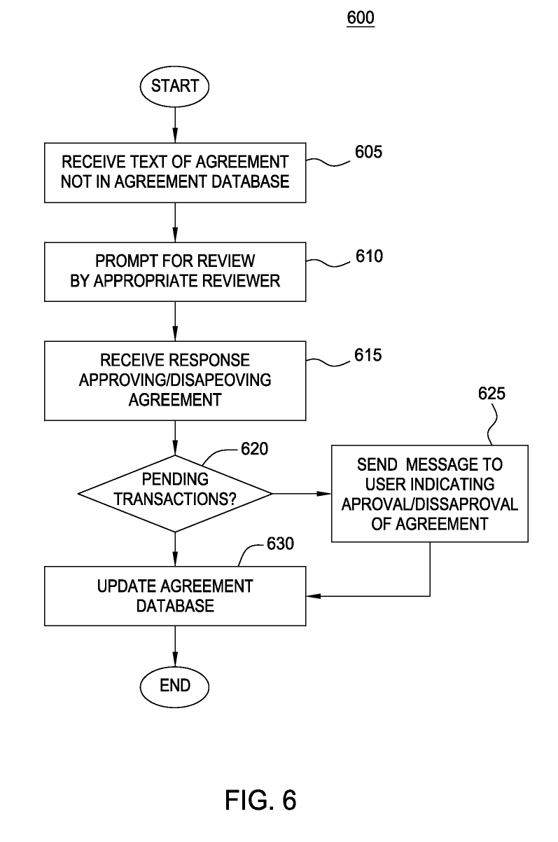

FIG. 6 illustrates a method of an exception process 600 used to approve (or disapprove) legal agreements encountered during a computer-facilitated workflow, according to one embodiment of the invention. As shown, the method 600 begins at step 605, where the license authorization application 110 receives the text of an agreement not in the agreements database 235. For example, as noted above, the user may submit an agreement presented as part of a computer-facilitated workflow that is not in the agreement database 235.

At step 610, the license authorization application 110 may send a message to the appropriate party to review the agreement. For example, the license authorization application 110 could be configured to email the text of the license agreement to a legal department within an organization. At step 615, the license authorization application 110 may receive a response from the reviewing entity indicating an approval or disapproval status that should be assigned to the agreement within the agreement database.

At step 620, the license authorization application 110 may determine whether the agreement is the subject of a pending transaction, i.e., whether a user is waiting for the “pending” status of an agreement to be updated. If so, at step 625, the license authorization application 110 may send a message to a user indicating the approval/disapproval status assigned to the agreement, allowing that user to either complete or discontinue a given particular computer-facilitated workflow. At step 630, the license authorization application 110 may create (or update) a record in the agreement database 235 indicating the approval/disapproval status assigned to the agreement.

Advantageously, embodiments of the invention disclose techniques for ensuring acceptability of legal agreements entered into as part of a computer-facilitated workflow, e.g., for accepting a license agreement while installing software on a computer system owned by an organization. If the license has an approved status in an agreements database, the user can accept the license agreement during the software install process. If the license has a disapproved status in the agreements database, the user then rejects the license agreement during the software install process (or an install mechanism may simply aborts installation of the software). The process for other computer-facilitated workflows is similar.

While the foregoing is directed to embodiments of the present invention, other and further embodiments of the invention may be devised without departing from the basic scope thereof, and the scope thereof is determined by the claims that follow.

What is claimed is:

1. A computer-implemented method for ensuring acceptability of an agreement entered into as part of a computer-facilitated workflow, the method comprising:
receiving, from a user engaging in the computer-facilitated workflow, a text representation of a first agreement presented to the user as a step of the computer-facilitated workflow;
comparing, by operation of a processor, the text representation of the first agreement to a text representation of a plurality of agreements stored in an agreements database;
determining, in response to the comparison, whether a first agreement matches a second agreement, the second agreement having an assigned status in the agreements database; and
transmitting, over a data communications network, an indication to the user of the assigned status of the second agreement.

2. The computer-implemented method of claim 1, wherein the assigned status is selected from at least one of an approved status, a disapproved status, and a pending status.

3. The computer-implemented method of claim 1, wherein the assigned status in the agreements database is determined based on a role assigned to the user engaging in the computer-facilitated workflow.

4. The computer-implemented method of claim 1, further comprising:
in response to determining the first agreement does not match the second agreement:
determining that the first agreement has a similarity score that exceeds a user specified threshold relative to a third agreement in the agreements database, the third agreement having an assigned status in the agreements database,
identifying textual differences between the first agreement and the third agreement, and
presenting an indication of the identified textual differences to the user.

5. The computer-implemented method of claim 4, further comprising, receiving, from the user, an indication of whether to assign, to the first agreement, the status assigned to the third agreement.

6. The computer-implemented method of claim 1, further comprising:
in response to determining the first agreement does not match the second agreement:
transmitting the text representation of the first agreement to a reviewing entity,
receiving, from the reviewing entity, a status to assign to the first agreement, and
storing a record in the agreements database, the record indicating the status assigned to the first agreement by the reviewing entity.

7. A computer-readable storage medium containing a program which, when executed by a processor, performs an operation for ensuring acceptability of an agreement entered into as part of a computer-facilitated workflow, the operation comprising:
receiving, from a user engaging in the computer-facilitated workflow, a text representation of a first agreement presented to the user as a step of the computer-facilitated workflow;
comparing, by operation of a processor, the text representation of the first agreement to a text representation of a plurality of agreements stored in an agreements database;
determining, in response to the comparison, whether a first agreement matches a second agreement, the second agreement having an assigned status in the agreements database; and
transmitting, over a data communications network, an indication to the user of the assigned status of the second agreement.

8. The computer-readable storage medium of claim 7, wherein the assigned status is selected from at least one of an approved status, a disapproved status, and a pending status.

9. The computer-readable storage medium of claim 7, wherein the agreement is a software license agreement and the computer-facilitated workflow comprises a software installation process.

10. The computer-readable storage medium of claim 7, wherein the assigned status in the agreements database is determined based on a role assigned to the user engaging in the computer-facilitated workflow.

11. The computer-readable storage medium of claim 7, wherein the operation further comprises:
in response to determining the first agreement does not match the second agreement:
determining that the first agreement has a similarity score that exceeds a user specified threshold relative to a third agreement in the agreements database, the third agreement having an assigned status in the agreements database,
identifying textual differences between the first agreement and the third agreement, and
presenting an indication of the identified textual differences to the user.

12. The computer-readable storage medium of claim 11, wherein the operation further comprises, receiving, from the user, an indication of whether to assign, to the first agreement, the status assigned to the third agreement.

13. The computer-readable storage medium of claim 7, wherein the operation further comprises:
in response to determining the first agreement does not match the second agreement:
transmitting the text representation of the first agreement to a reviewing entity,
receiving, from the reviewing entity, a status to assign to the first agreement, and
storing a record in the agreements database, the record indicating the status assigned to the first agreement by the reviewing entity.

14. A system, comprising:
one or more computer processors; and
a memory containing a program, which when executed by the one or more computer processors is configured to perform an operation for ensuring acceptability of an agreement entered into as part of a computer-facilitated workflow, the operation comprising:
receiving, from a user engaging in the computer-facilitated workflow, a text representation of a first agreement presented to the user as a step of the computer-facilitated workflow,
comparing, by operation of a processor, the text representation of the first agreement to a text representation of a plurality of agreements stored in an agreements database,
determining, in response to the comparison, whether a first agreement matches a second agreement, the second agreement having an assigned status in the agreements database, and
transmitting, over a data communications network, an indication to the user of the assigned status of the second agreement.

15. The system of claim 14, wherein the assigned status is selected from at least one of an approved status, a disapproved status, and a pending status.

16. The system of claim 14, wherein the agreement is a software license agreement and the computer-facilitated workflow comprises a software installation process.

17. The system of claim 14, wherein the assigned status in the agreements database is determined based on a role assigned to the user engaging in the computer-facilitated workflow.

18. The system of claim 14, wherein the operation further comprises:
in response to determining the first agreement does not match the second agreement:
determining that the first agreement has a similarity score that exceeds a user specified threshold relative to a third agreement in the agreements database, the third agreement having an assigned status in the agreements database,
identifying textual differences between the first agreement and the third agreement, and
presenting an indication of the identified textual differences to the user.

19. The system of claim 18, wherein the operation further comprises, receiving, from the user, an indication of whether to assign, to the first agreement, the status assigned to the third agreement.

20. The system of claim 14, wherein the operation further comprises:
in response to determining the first agreement does not match the second agreement:
transmitting the text representation of the first agreement to a reviewing entity,
receiving, from the reviewing entity, a status to assign to the first agreement, and
storing a record in the agreements database, the record indicating the status assigned to the first agreement by the reviewing entity.

21. A computer-implemented method for ensuring acceptability of a software license entered into as part of a software installation workflow, the method comprising:
receiving, from a user engaging in the software installation process, a text representation of the software license presented to the user as a step of the software installation process;
comparing, by operation of a processor, the text representation of the software license to a text representation of a plurality of software licenses stored in a database;
determining, in response to the comparison, whether the software license matches at least a second software license in the database, the second software license having an assigned status in the agreements database; and
transmitting, over a data communications network, an indication to the user of the assigned status of the second software license agreement.

22. The computer-implemented method of claim 21, further comprising:
in response to determining the assigned status of the second license agreement is an approved status, installing a software application associated with the first license agreement.

23. The computer-implemented method of claim 21, further comprising:
in response to determining the software license does not match the second software license:
transmitting the text representation of the software license to a reviewing entity,
receiving, from the reviewing entity, a status to assign to the software license, and
storing a record in the database, the record indicating the status assigned to the software license by the reviewing entity.
